(19) United States
(12) Patent Application Publication
(10) Pub. No.: US 2011/0099332 A1
(43) Pub. Date: Apr. 28, 2011

(54) METHOD AND SYSTEM OF OPTIMAL CACHE ALLOCATION IN IPTV NETWORKS

(75) Inventors: Lev B. Sofman, Allen, TX (US); Bill Krogfoss, Frisco, TX (US); Anshul Agrawal, Plano, TX (US)

(73) Assignee: ALCATEL-LUCENT USA INC., Murray Hill, NJ (US)

(21) Appl. No.: 12/673,188

(22) PCT Filed: Aug. 29, 2008
(86) PCT No.: PCT/US08/10269

§ 371 Date: Feb. 12, 2010

Related U.S. Application Data
(60) Provisional application No. 60/969,162, filed on Aug. 30, 2007.

(51) Int. Cl. G06F 12/08

(52) U.S. Cl. 711/118; 711/E12.017

(57) ABSTRACT

In an IPTV network, one or more caches may be provided at the network nodes for storing video content in order to reduce bandwidth requirements. Cache functions such as cache effectiveness and cacheability may be defined and optimized to determine the optimal size and location of cache memory and to determine optimal partitioning of cache memory for the unicast services of the IPTV network.

### CROSS REFERENCE TO RELATED APPLICATIONS

This application claims the benefit of U.S. Provisional Application No. 60/969,162 filed Aug. 30, 2007, and PCT/US08/10269 filed Aug. 29, 2008, the disclosures of which are incorporated herein by reference.

### FIELD OF THE INVENTION

This invention relates to Internet Protocol Television (IPTV) networks and in particular to caching of video content at nodes within the network.

### BACKGROUND OF THE INVENTION

In an IPTV network, Video on Demand (VOD) and other video services generate large amounts of unicast traffic from a Video Head Office (VHO) to subscribers and, therefore, require significant bandwidth and equipment resources in the network. To reduce this traffic, and subsequently the overall network cost, part of the video content, such as most popular titles, may be stored in caches closer to subscribers. For example, a cache may be provided in a Digital Subscriber Line Access Multiplexer (DSLAM), Central Office (CO) or in Intermediate Offices (IO). Selection of content for caching may depend on several factors including size of the cache, content popularity, etc.

What is required is a system and method for optimizing the size and locations of cache memory in IPTV networks.

### SUMMARY OF THE INVENTION

In one aspect of the disclosure, there is provided a method for optimizing a cache memory allocation of a cache at a network node of an Internet Protocol Television (IPTV) network comprising defining a cacheability function and optimizing the cacheability function.

In one aspect of the disclosure, there is provided a network node of an Internet Protocol Television network comprising a cache, wherein a size of the memory of the cache is in accordance with an optimal solution of a cache function for the network.

In one aspect of the disclosure, there is provided a computer-readable medium comprising computer-executable instructions for execution by a first processor and a second processor in communication with the first processor, that, when executed cause the first processor to provide input parameters to the second processor, and cause the second processor to calculate at least one cache function for a cache at a network node of an IPTV network.

### BRIEF DESCRIPTION OF THE DRAWINGS

Reference will now be made to specific embodiments, presented by way of example only, and to the accompanying drawings in which:

FIG. 1 is a schematic of an IPTV network;

FIG. 2 illustrates a popularity distribution curve;

FIG. 3 illustrates a transport bandwidth problem;

FIG. 4 illustrates an input parameter table;

FIG. 5 illustrates a network cost calculation flowchart;

FIG. 6 illustrates an optimization of a cache function; and

FIG. 7 illustrates a system processor and a user processor.

### DETAILED DESCRIPTION OF THE INVENTION

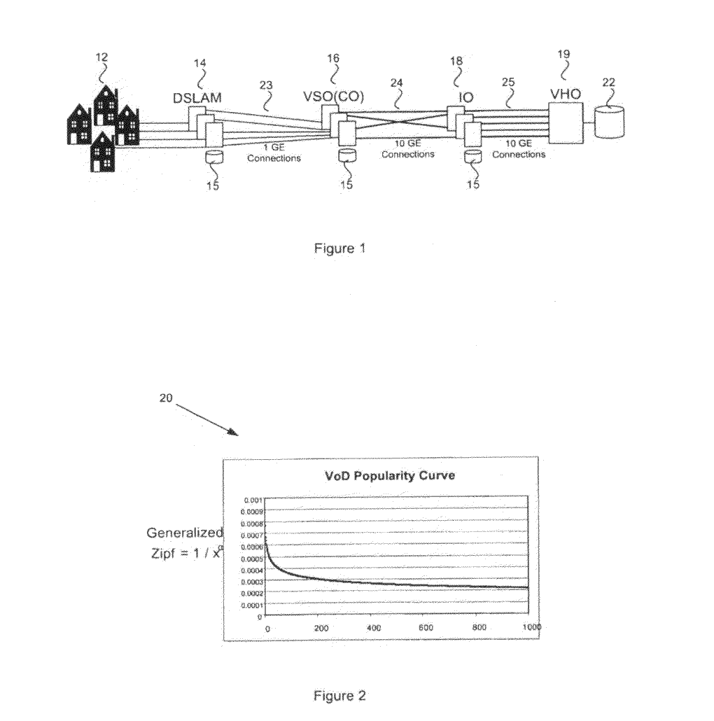

In a typical IPTV architecture 10, illustrated in FIG. 1, several subscribers 12 are connected to a Digital Subscriber Line Access Multiplexer (DSLAM) 14 (e.g., 192:1 ratio). The DSLAMs 14 are connected to a Central Office CO 16 (e.g., 100:1 ratio). Several COs 16 are connected to an Intermediate Office (IO) 18 and finally to a Video Home Office (VHO) 19 (e.g., 6:1 ratio). The VHO 19 stores titles of Video On Demand (VoD) content, e.g. in a content database 22. 1 Gigabit Ethernet (GE) connections 23 connect the DSLAMs 14 to the COs 16 while 10GE connections 24, 25 respectively connect the COs 16 to the IOs 18 and the IOs 18 to the VHO 19.

To reduce the cost impact of unicast VoD traffic on the IPTV network 10, part of the video content may be stored in caches closer to the subscribers. In various embodiments, caches may be provided in some or all of the DSLAMs, COs or IOs. In one embodiment, a cache may be provided in the form of a cache module 15 that can store a limited amount of data, e.g. up to 3000 TeraBytes (TB). In addition, each cache module may be able to support a limited amount of traffic, e.g. up to 20 Gbs. The cache modules are convenient because they may be provided to use one slot in corresponding network equipment.

In one embodiment, caches are provided in all locations of one of the layers, e.g. DSLAM, CO, or IO. That is, a cache will be provided in each DSLAM 14 of the network, or each CO 16 or each IO 18.

The effectiveness of each cache may be described as the percentage of video content requests that may be served from the cache. Cache effectiveness is a key driver of the economics of the IPTV network.

Cache effectiveness depends on several factors including the number of titles stored in the cache (which is a function of cache memory and video sizes) and the popularity of titles stored in the cache which can be described by a popularity distribution.

Cache Effectiveness increases as cache memory increases, but so do costs. Transport costs of video content are traded for the combined cost of all of the caches on the network. Cache effectiveness is also a function of the popularity curve. An example of a popularity distribution 20 is shown in FIG. 2. The popularity distribution curve 20 is represented by a Zipf or generalized Zipf function:

Zipf=1/x^{a}

As the popularity curve flattens cache effectiveness decreases.

In order to find optimal location and size of cache memory, an optimization model and tool is provided. The tool selects an optimal cache size and its network location given typical metro topology, video contents popularity curves, cost and traffic assumptions, etc. In one embodiment, the tool also optimizes the entire network cost based on the effectiveness of the cache, its location and so on. Caching effectiveness is a function of memory, and popularity curve, with increasing memory causing an increased efficiency (and cache costs), but reduced transport costs. The optimization tool may therefore be used to select the optimal memory for the cache to reduce overall network costs.

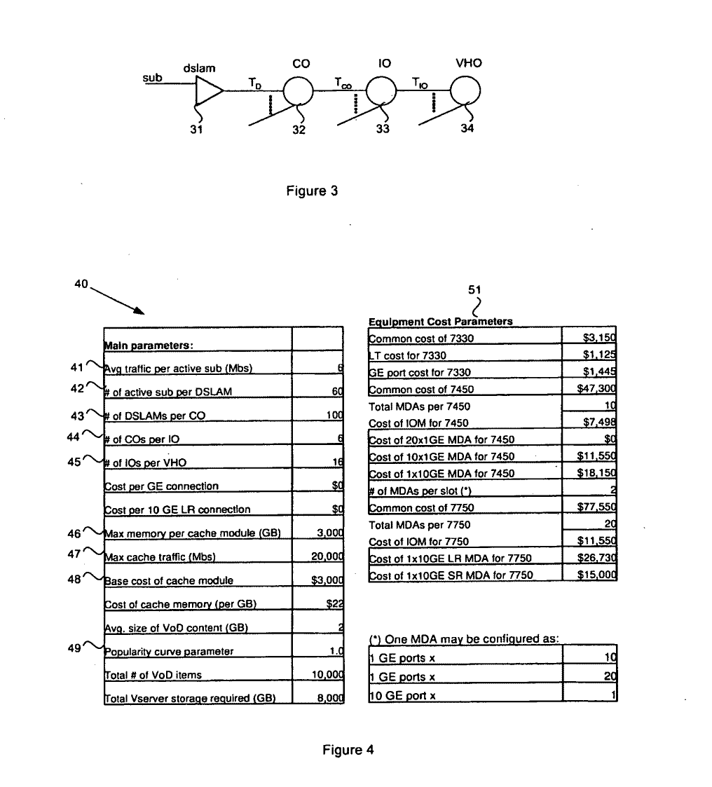

An element of the total network cost is the transport bandwidth cost. Transport bandwidth cost is a function of bandwidth per subscriber and the number of subscribers. Caching reduces bandwidth upstream by the effectiveness of the cache, which, as described above, is a function of the memory and popularity distribution. The transport bandwidth cost problem is depicted graphically in FIG. 3. T_{d} represents the transport cost to the DSLAM node (d) 31 and is dependent on the number of subscribers (sub) and the bandwidth (BW) per subscriber. T_{d} can therefore be represented as:

T_{d}=#sub*BW/sub

T_{CO} is the transport cost to the Central Offices 32 and is represented as:

T_{co}=#d*T_{d}

T_{IO} is the transport cost to the Intermediate Offices 33 and is represented as:

T_{IO}=#IO*Tco

VHO Traffic is the transport cost of all VHO traffic on the network from the VHO 34 and is represented as:

VHO Traffic=τT_{IO}

The required transport bandwidth can be used for dimensioning equipment such as the DSLAMs, COs and IOs and determining the number of each of these elements required in the network.

FIG. 4 shows a parameter table 40 of input parameters for an optimization tool. Sample data for the parameter table 40 is also provided. For example the parameter table allows a user to enter main parameters such as average traffic per active subscriber 41 and number of active subscribers per DSLAM 42. Network configuration parameters may be provided such as number of DSLAMs 43, COs 44, and IOs 45. Cache module parameters may be provided such as memory per cache module 46, max cache traffic 47, and cost of cache module 48. A popularity curve parameter 49 may also be entered. Other network equipment costs 51 such as switches, routers and other hardware components may also be prescribed.

The parameter table 40 may be incorporated into a wider optimization tool for use in a network cost calculation.

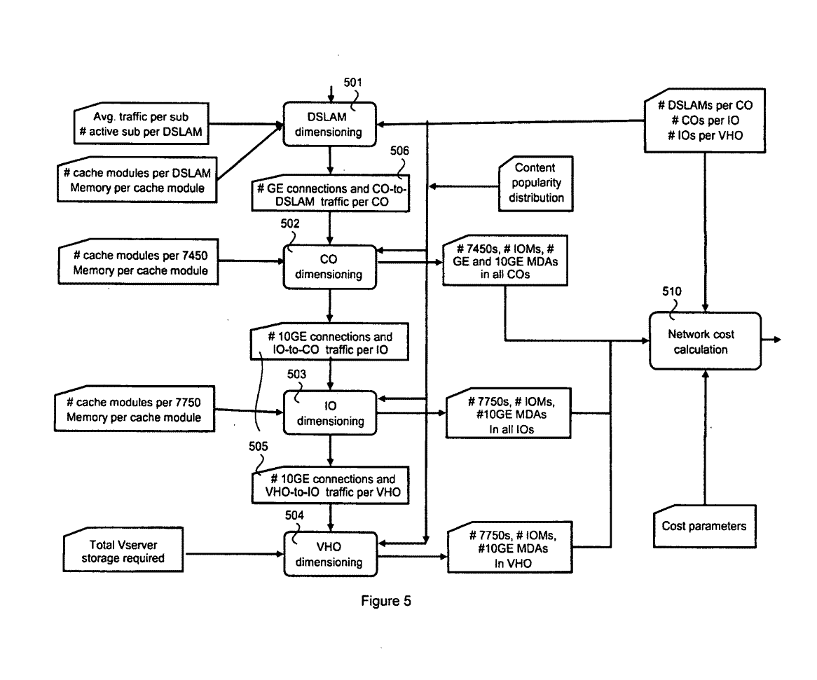

A flowchart 50 for determining network cost is illustrated in FIG. 5. The network cost may be expressed as:

Network Cost 510=Equipment Cost+Transport Cost.

The Equipment Cost is the cost of all DSLAMs, COs, IOs and VHO as well as the VoD servers and caches. The Equipment cost can be broken down by considering the dimensioning for each of the DSLAM, CO and IO. DLSAM dimensioning (step 501) requires cost considerations of:
a. Total cache memory per DSLAM=cache memory per unit×# of cache units per DSLAM;
b. # of content units in cache=total cache memory per DSLAM/avg. memory requirement per unit of content;
c. Cache effectiveness (i.e. % of requests served by cache)=CDF−1(# of content units in cache), where CDF is Cumulative Density Function of popularity distribution;
d. Total cache throughput=# of cache units×cache throughput per unit;
e. Total traffic demand from all subscribers connected to DSLAM (DSLAM-Traffic)=# of subscribers per DSLAM×avg. traffic per subscriber;
f. CO-to-DSLAM traffic per DSLAM=DSLAM-Traffic−min(total cache throughput, cache effectiveness×DSLAM-Traffic);
g. #GE connections/DSLAM=┌CO-to-DSLAM traffic per DSLAM/1 Gbs┐; and
h. # LT per DSLAM=┌# of subscribers per DSLAM/24┐;

CO dimensioning (step 502) requires:
a. # of GE connections facing DSLAMs per CO=# GE connections per DSLAM×# DSLAMs per CO;
b. total traffic demand from all DSLAMs connected to CO (CO-Traffic)=CO-to-DSLAM traffic per DSLAM×# of DSLAMs per CO;
c. avg. GE utilization=CO-Traffic/# GE connections facing DSLAMs per CO;
d. calculation of a maximum number (n) of GE ports facing DSLAM per Ethernet Service Switch (e.g. the 7450 Ethernet Service Switch produced by Alcatel Lucent) such that ┌n/# GE ports per MDA┐+┌IO-to-CO traffic per 7450/10 Gbs┐≦10−2×# cache units per 7450, where:
   i. IO-to-CO traffic per 7450=CO-to-DSLAM traffic per 7450−min(total cache throughput, cache effectiveness×CO-to-DSLAM traffic per 7450); and
   ii. CO-to-DSLAM traffic per 7450=n×avg. GE utilization;
e. # of 7450 per CO=┌# GE connections facing DSLAMs per CO/n┐;
f. # of 10 GE ports facing IO per 7450=┌IO-to-CO traffic per 7450/10 Gbs┐;
g. Calculation of a total number of GE MDAs, 10GE MDAs, and IOMs per CO.

IO Dimensioning (step 503) requires:
a. # 10 GE connections facing COs per IO=# 10 GE connections per CO×# COs per IO;
b. total traffic demand from all COs connected to IO (IO-Traffic)=IO-to-CO traffic per CO×# of COs per IO;
c. avg. 10 GE utilization=IO-Traffic/# 10 GE connections facing COs per IO;
d. calculation of a maximum # (m) of 10 GE ports facing CO per Service Router (e.g. the 7750 service router by Alcatel-Lucent) such that ┌m/# 10 GE ports per MDA┐+┌VHO-to-IO traffic per 7750/10 Gbs┐≦20−2×# cache units per 7750, where:
   i. VHO-to-IO traffic per 7750=IO-to-CO traffic per 7750−min(total cache throughput, cache effectiveness×IO-to-CO traffic per 7750); and
   ii. IO-to-CO traffic per 7750=m×avg. 10 GE utilization;
e. # of 7750 per IO=┌#10 GE connections facing COs per IO/m┐;
f. # of 10 GE ports facing VHO per 7750=┌VHO-to-IO traffic per 7750/10 Gbs┐;
g. Calculation of a total number of 10 GE MDAs and IOMs per IO.

VHO dimensioning (step 504) requires:
a. # 10 GE connections facing IOs per VHO=# 10 GE VHO-IO connections per IO×# IOs per VHO;
b. total traffic demand from all IOs connected to VHO (VHO-Traffic)=IO-to-CO traffic per CO×# of COs per IO;
c. avg. 10 GE utilization=VHO-Traffic/# 10 GE connections facing IOs per VHO;
d. calculation of a maximum # (k) of 10 GE ports facing IO per 7750 (Service Router) in VHO such that ┌k/# 10 GE ports per MDA┐+┌VHO-to-IO traffic per 7750/10 Gbs┐≦20, where:
   i. VHO-to-IO traffic per 7750 in VHO=k×avg. 10 GE utilization;
e. # of 7750 per VHO=┌# 10 GE connections facing IOs per VHO/k┐;
f. # of 10 GE ports facing VoD server per 7750 in VHO=┌VHO-to-IO traffic per 7750/10 Gbs┐;
g. Calculation of a total number of 10 GE MDAs and IOMs per VHO.

The equipment cost will also include the cache cost, which is equal to the common cost of the cache plus the memory cost. The transport cost of the network will be the cost of all GE connections 506 and 10 GE connections 505 between the network nodes.

Different video services (e.g. VoD, NPVR, ICC, etc) have different cache effectiveness (or hit rates) and different size of titles. A problem to be addressed is how can a limited resource, i.e. cache memory, be partitioned between different services in order to increase the overall cost effectiveness of caching.

The problem of optimal partitioning of cache memory between several unicast video services may be considered as a constraint optimization problem similar to the “knapsack problem”, and may be solved by, e.g. method of linear integer programming. However, given the number of variables described above, finding a solution may take significant computational time. Thus, in one embodiment of the disclosure, the computational problem is reduced by defining a special metric—“cacheability”—to speed-up the process of finding the optimal solution. The cacheability factor takes into account cache effectiveness, total traffic and size of one title per service. The method uses the cacheability factor and iterative process to find the optimal number of cached titles (for each service) that will maximize overall cache hit rate subject to the constraints of cache memory and throughput limitations.

Cache Effectiveness function (or Hit Ratio function) depends on statistical characteristics of traffic (long- and short-term title popularity) and on effectiveness of a caching algorithm to update cache content. Different services have different Cache Effectiveness functions. A goal is to maximize cache effectiveness subject to the limitations on available cache memory M and cache traffic throughput T. In one embodiment, Cache effectiveness is defined as a total cache hit rate weighted by traffic amount. In an alternative embodiment, cache effectiveness may be weighted with minimization of used cache memory.

The problem can be expressed as a constraint optimization problem, namely:

maxΣᵢ₌₁ⁿTᵢFᵢ(└Mᵢ/Sᵢ┘)

subject to:

Σᵢ₌₁^{N}Mᵢ≦M

and

Σᵢ₌₁^{N}TᵢFᵢ(└Mᵢ/Sᵢ┘)≦T

where
└x┘—max integer that<x;
N—total number of services;
Tᵢ—traffic for service i, i=1, 2, . . . , N;
Fᵢ (n)—cache effectiveness as a function of number of cached titles n, for service i, i=1, 2, . . . , N;
Mi—cache memory for service i, i=1, 2, . . . , N;
Si—size per title for service i, i=1, 2, . . . , N.

The cache effectiveness Fᵢ (n) is a ratio of traffic for the i-th service that may be served from the cache if n items (titles) of this service may be cached.

This problem may be formulated as a Linear Integer Program and solved by LP Solver.

Continuous formulation of this problem is similar to the formulation above:

maxΣᵢ₌₁ⁿTᵢFᵢ(Mᵢ/Sᵢ)

subject to

Σᵢ₌₁^{N}Mᵢ≦M

and

Σᵢ₌₁^{N}TᵢFᵢ(Mᵢ/Sᵢ)≦T

and may be solved using a Lagrange Multipliers approach. The Lagrange multipliers method is used for finding the extrema of a function of several variables subject to one or more constraints and is a basic tool in nonlinear constrained optimization. Lagrange multipliers compute the stationary points of the constrained function. Extrema occur at these points, or on the boundary or at points where the function is not differentiable. Applying the method of Lagrange multipliers to the problem:

$$\frac{d}{d {M}_{i}} ( {\sum }_{i = 1}^{n} {T}_{i} {F}_{i} ( {M}_{i} / {S}_{i} ) - {λ}_{1} {\sum }_{i = 1}^{N} {M}_{i} - {λ}_{2} {\sum }_{i = 1}^{n} {T}_{i} {F}_{i} ( {M}_{i} / {S}_{i} ) ) = 0$$

$$or$$

$$\frac{{T}_{i}}{{S}_{i}} \frac{d {F}_{i}}{d {M}_{i}} ( \frac{{M}_{i}}{{S}_{i}} ) = \frac{{λ}_{2}}{1 - {λ}_{1}} \\ for i = 1 , 2 , … , N .$$

These equations describe stationary points of the constraint function. An optimal solution may be achieved in stationary points or on the boundary (e.g., where Mi=0 or Mi=M).

In the following a “cacheability” function is defined:

$${f}_{i} ( m ) = \frac{{T}_{i}}{{S}_{i}} {F}_{i} ( \frac{m}{{S}_{i}} )$$

that quantifies the benefit of caching per unit of used memory (m) for the i-th service (i=1, 2, . . . , N).

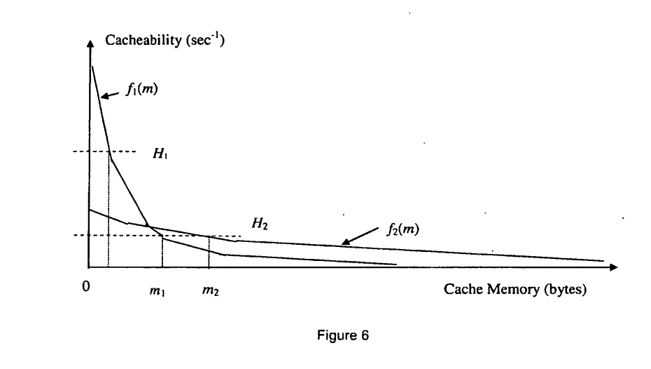

To illustrate how cacheability functions may be used to find optimal solution of this problem a simplified example having only two services may be considered. If the functions f1 and f2 are plotted on the same chart (FIG. 6), then for every horizontal line H (horizon) that intersects the cacheability curves f1 and f2, there may be estimated an amount of cache memory used for service and corresponding traffic throughput. When the horizon H is moved down, the amount of used cache memory increases as well as traffic throughput. When a memory or traffic limit is reached (whichever comes first), an optimal solution is achieved. Depending on the situation, optimal solution may be achieved when the horizon intersects (a) one curve (horizon H1) or (b) both curves (horizon H2). In case (a) cache memory should be assigned for only one service (f1); in case (b) both of services f1 and f2 should share cache memory in caches m₁ and m₂.

Once cache memories have been determined using the cacheability functions and cache effectiveness functions, the cache allocations can be inserted into the network cost calculations for determining total network costs. In addition, the cacheability functions and cache effectiveness functions can be calculated on an ongoing basis in order to ensure that the cache is partitioned appropriately with cache memory dedicated to each service in order to optimize the cache performance.

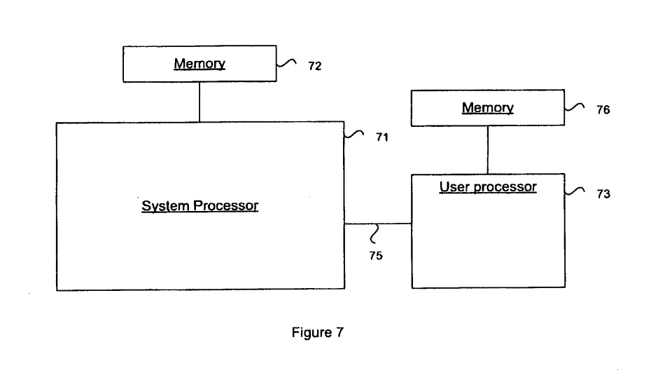

In one embodiment, the optimization tool may be embodied on one or more processors as shown in FIG. 7. A first processor 71 may be a system processor operatively associated with a system memory 72 that stores an instruction set such as software for calculating a cacheability function and/or a cache effectiveness function. The system processor 71 may receive parameter information from a second processor 73, such as a user processor which is also operatively associated with a memory 76. The memory 76 may store an instruction set that when executed allows the user processor 73 to receive input parameters and the like from the user. A calculation of the cacheability function and/or the cache effectiveness function may be performed on either the system processor 71 or the user processor 73. For example, input parameters from a user may be passed from the user processor 73 to the system processor 71 to enable the system processor 71 to execute instructions for performing the calculation. Alternatively, the system processor may pass formulas and other required code from the memory 72 to the user processor 73 which, when combined with the input parameters, allows the processor 73 to calculate cacheability functions and/or the cache effectiveness function. It will be understood that additional processors and memories may be provided and that the calculation of the cache functions may be performed on any suitable processor. In one embodiment, at least one of the processors may be provided in a network node and operatively associated with the cache of the network node so that, by ongoing calculation of the cache functions, the cache partitioning can be maintained in an optimal state.

Although embodiments of the present invention have been illustrated in the accompanied drawings and described in the foregoing description, it will be understood that the invention is not limited to the embodiments disclosed, but is capable of numerous rearrangements, modifications, and substitutions without departing from the spirit of the invention as set forth and defined by the following claims. For example, the capabilities of the invention can be performed fully and/or partially by one or more of the blocks, modules, processors or memories. Also, these capabilities may be performed in the current manner or in a distributed manner and on, or via, any device able to provide and/or receive information. Further, although depicted in a particular manner, various modules or blocks may be repositioned without departing from the scope of the current invention. Still further, although depicted in a particular manner, a greater or lesser number of modules and connections can be utilized with the present invention in order to accomplish the present invention, to provide additional known features to the present invention, and/or to make the present invention more efficient. Also, the information sent between various modules can be sent between the modules via at least one of a data network, the Internet, an Internet Protocol network, a wireless source, and a wired source and via plurality of protocols.

What is claimed is:

1. A method for optimizing a cache memory allocation of a cache at a network node of an Internet Protocol Television (IPTV) network comprising:
defining a cacheability function; and
optimizing the cacheability function.

2. The method according to claim 1 wherein optimizing the function comprises applying a memory limit to the cacheability function.

3. The method according to claim 1 wherein optimizing the cacheability function comprises applying a throughput traffic limit to the cacheability function.

4. The method according to claim 1 wherein the cacheability function determines a cacheability factor for the i-th service of N services of the IPTV network.

5. The method according to claim 1 wherein the cacheability function comprises a cacheability effectiveness function.

6. The method according to claim 1 wherein the cacheability calculates a cacheability factor fᵢ(m) for the i-th service of a network node, wherein
$${f}_{i} ( m ) = \frac{{T}_{i}}{{S}_{i}} {F}_{i} ( \frac{m}{{S}_{i}} )$$
where
Tᵢ is traffic for service i,
Sᵢ is size per title for service i,
Fᵢ(m/Sᵢ) is a cache effectiveness function for service i.

7. The method according to claim 6 comprising determining the cache effectiveness function.

8. The method according to claim 7 wherein determining the cache effectiveness function comprises solving the equation
$$\frac{d}{d {M}_{i}} ( {\sum }_{i = 1}^{n} {T}_{i} {F}_{i} ( {M}_{i} / {S}_{i} ) - {λ}_{1} {\sum }_{i = 1}^{N} {M}_{i} - {λ}_{2} {\sum }_{i = 1}^{n} {T}_{i} {F}_{i} ( {M}_{i} / {S}_{i} ) ) = 0 ;$$
where Mᵢ is the cache memory for service i and λ₁ and λ₂ are Lagrange Multipliers.

9. The method according to claim 8 wherein Mᵢ≦M, wherein M is a size of a cache memory.

10. The method according to claim 9 wherein M is a size of at least one cache memory module at the network node.

11. The method according to claim 8 further comprising allocating a memory (m) to the i-th service in accordance with an optimized solution of the cache effectiveness function.

12. A network node of an Internet Protocol Television network comprising a cache, wherein a size of the memory of the cache is in accordance with an optimal solution of a cache function for the network.

13. The network node according to claim 12 wherein the cache function comprises a cache effectiveness function.

14. The network node according to claim 12 wherein the cache comprises at least one cache module.

15. The network node according to claim 14 wherein the cache function partitions the at least one cache module in order to optimize a cache effectiveness function.

16. The network node according to claim 15 wherein cache memory is allocated to an i-th service of the network such that a cache effectiveness function is optimized.

17. The network node according to claim 16 wherein the cache effectiveness function for an i-th service of the network is determined by solving
maxΣᵢ₌₁ⁿTᵢFᵢ(Mᵢ/Sᵢ)
subject to
Σᵢ₌₁^{N}Mᵢ≦M and
Σᵢ₌₁^{N}TᵢFᵢ(Mᵢ/Sᵢ)≦T
where
└x┘—max integer that<x,
N—total number of services,
Tᵢ—traffic for service i, i=1, 2, . . . , N,
Fᵢ (n)—cache effectiveness as a function of number of cached titles n, for service i, i=1, 2, . . . , N,
Mᵢ—cache memory for service i, i=1, 2, . . . , N, and
Sᵢ—size per title for service i, i=1, 2, . . . , N.

18. A computer-readable medium comprising computer-executable instructions for execution by a first processor and a second processor in communication with the first processor, that, when executed:
cause the first processor to provide input parameters to the second processor; and
cause the second processor to calculate at least one cache function for a cache at a network node of an IPTV network.

19. The computer readable medium according to claim 18 wherein the cache function comprises a cache effectiveness function.

20. The computer readable medium according to claim 18 wherein the cache function comprises a cacheability function.
